(19) United States
(12) Patent Application Publication
(10) Pub. No.: US 2004/0068429 A1
(43) Pub. Date: Apr. 8, 2004

(54) Strategic organization plan development and information present system and method

(76) Inventor: Ian D MacDonald, Columbia, SC (US)

Correspondence Address: John B Hardaway, III, Nexsen Pruet Jacobs & Pollard, P O Box 10107, Greenville, SC, 29603, US

(21) Appl. No.: 10/398,504

(22) PCT Filed: Oct. 2, 2001
(86) PCT No.: PCT/US01/30798

(51) Int. Cl. G06F 17/60

(52) U.S. Cl. 705/10

(57) ABSTRACT

The invention is a system and method for developing a strategic organization plan and for presenting the information associated with such plan through the use of a computer spreadsheet-based presentation system. The invention combines Strategic Performance Measurement Consulting, which uses a modified version of the “Balanced Business Scorecard” system, with spreadsheet application technology to create an information presentation system that can he implemented on a single workstation, or through the use of a computer network, an intranet, or the internet, can he accessed and used by all of the organization's decision makers, including the organization's rank and file employees.

### FIELD OF THE INVENTION

The present invention relates to methods and tools used by businesses and other organizations for implementing organization plans for such businesses or other entities, and more particularly to the systems and methods used for developing and implementing strategic organization plans through the use of computer spreadsheet technology.

### BACKGROUND OF THE INVENTION

Businesses and other organizations are always looking for ways to improve their performance. Some businesses focus on improving theirs employees' efficiency and productivity, while others look for ways to improve their customers' level of satisfaction with the business. In the current competitive marketplace it is extremely important for a business to know where it stands with respect to its competition, to know where it wants to go in the future, and to be able to develop management plans to get it there. What today's businesses have at their disposal is the ability to track the data associated with a myriad of business indicators. However, even with the aid of modem computer hardware and software, the number of different indicators and the number of datapoints that can be collected for these indicators can become overwhelming to the point of being unusable and, therefore, worthless to the business. Some businesses try to compensate for this by just using financial indicators, and while these may be extremely useful to a business they do not always capture the overall outlook of the business. Therefore, many business managers have been exploring other methods or ways of predicting and managing their business's success.

What many business managers have discovered is that there are barriers to bringing about improvements through strategic change. These barriers generally include: difficulty in determining what should be measured and how; too much data to sift through; too much emphasis on short-term results and not enough on long-term strategies; and poor implementation of their strategic plans.

Because of this need, business managers, business school professors, industrial sociologists and others have studied, categorized and analyzed the characteristics of successful businesses, and from this field of study and research many interesting theories and solutions have evolved. One such popular solution is the strategic management system known as the Balanced Business Scorecard. The Balanced Business Scorecard is a conceptual tool that was developed by Robert Kaplan and David Norton both of the Harvard Business School, and it appeared in: Kaplan, Robert S. and Norton, David P., The Balanced Scorecard: Measures that Drive Performance, Harvard Business Review (January-February, 1992), and Kaplan, Robert S. and Norton, David P., The Balanced Scorecard: Translating Strategy Into Action, Boston, Mass.: Harvard Business School Press, 1996. The Balanced Business Scorecard can functionally be defined as a method of establishing and gauging a business's success by focusing on four business perspectives: a financial perspective; a customer satisfaction perspective; an internal business environment perspective; and an organizational learning, employee based perspective. Based on these perspectives, the Balanced Scorecard method requires a business to first establish its goals and to identify the factors that are essential to its success. Next, the business assigns measurable key performance indicators to these factors in order for every level of management and, possibly, for every employee, to be able to gauge and manage the business's ability to meet its goals.

Even though the Balanced Business Scorecard method provides businesses with a valuable tool many businesses still find that developing a strategic plan is problematic, but it is the Applicant's belief, that many more businesses find that the most troublesome issue resides in the implementation of such a strategic plan. This is where most companies fail to reap the strategic and operational benefits that they had hoped to achieve. Many of these businesses find that they are unable to establish and translate the vision in a meaningful way, and to share and communicate the strategic vision from the top to the bottom of their organizations.

It has been stated that business management applications based on the Balanced Business Scorecard method and/or system are very popular with today's businesses, but many businesses are still in search for a better solution, since many of the problems mentioned are still encountered. One such attempt at a solution, which is currently available in the marketplace, is Cognos Incorporated's Cognos Enterprise Business Intelligence Platform software. This software uses a form of the Balanced Business Scorecard system, which they refer to as “distributed scorecarding.” In “distributed scorecarding” the information, through the use of data-warehousing, and the use of the internet and/or an intranet, is assembled and disseminated throughout the business. This invention, however, relies on the installation of new hardware, the implementation of new software, and the implementation of new databases, which may be cost prohibitive to some businesses and which could require a long implementation timeline.

Therefore, with this stated, there still remains a need for an effective, low cost, quick to install, and easy to use organization performance management system.

### SUMMARY OF THE INVENTION

According to its major aspects and briefly recited, the present invention is a system and method for developing a strategic organization plan and for implementing such plan through a computer spreadsheet-based presentation system. Broadly stated, the present invention combines the benefits of the Balanced Business Scorecard with the strengths of technology to create a dynamic new management tool.

The invention combines Strategic Performance Measurement Consulting, which uses a modified version of the Kaplan and Norton Balanced Business Scorecard system, with spreadsheet application technology to create an information presentation system that can be used on a single workstation, or through the use of a computer network, an intranet, or the internet, can be accessed and used by all of the organization's decision makers, including the organization's rank and file employees as well.

A feature of using the Balanced Business Scorecard Strategic Performance Measurement Consulting System and Method, (“Consulting System”), in combination with the spreadsheet-based Information Presentation System and Method, (“Information Presentation System”), is that the combination is organized in a way that allows the organization to quickly and efficiently focus the organization's intellectual capital resources toward the task of achieving the goals that are established for the organization by the Consulting System, and it attempts to foster an organization-wide performance commitment from all of its employees.

The advantages of this combination include: the organization's strategic vision being communicated and implemented throughout the organization; the enabling of the organization's leadership to focus on their organization's customized list of Critical Success Factors; the shift to using long-term goals as the driving force in a organization's strategic plan rather than short-term results; the capture of the dynamics associated with the organization and the organization's environment including, if appropriate, its competition; the building of a knowledge-based information system that captures and shares the organization's intellectual capital; and the linkage of the organization's strategic plan with the organization's planning and budgeting functions and the human resources functions, in order to allow the organization the opportunity to develop overall “performance commitment” from the entire organization-in other words, the present invention provides the organization with an opportunity to create the impetus to define and drive the “culture” of the entire organization.

These and other features and their advantages will be apparent to those skilled in the art from a careful reading of the Detailed Description of a Preferred Embodiment presented below and accompanied by the following drawings.

### BRIEF DESCRIPTION OF THE DRAWINGS

FIG. 1A is a block diagram of a computer system in which the present invention may be embodied;

FIG. 1B is a block diagram of the Information Presentation System of the present invention, which includes an operating system, application software, and input and output devices;

FIG. 1C is a block diagram of a Data Map, according to a preferred embodiment of the present invention;

FIG. 2A is a block diagram of the Strategic Organization Plan Development System and Method, including the Strategic Business Plan, according to a preferred embodiment of the present invention;

FIG. 2B is a block diagram of a representation of the Balanced Business Scorecard;

FIG. 2C is a block diagram/timeline of a preferred embodiment of the Strategic Organization Plan Development System and Method;

FIG. 3 is a bitmap showing a typical Spreadsheet Application Screen Template that can be used with the present invention, according to a preferred embodiment of the Information Presentation System;

FIG. 3A is a bitmap showing the Main Screen, according to a preferred embodiment of the Information Presentation System;

FIG. 4 is a bitmap showing the Cause & Effect Screen, according to a preferred embodiment of the Information Presentation System;

FIG. 5 is a bitmap showing one of the KPI Results Screens, according to a preferred embodiment of the Information Presentation System;

FIG. 6 is a bitmap showing one of the Description Screens, according to a preferred embodiment of the Information Presentation System;

FIG. 7 is a bitmap showing one of the Targets Screens, according to a preferred embodiment of the Information Presentation System;

FIG. 8 is a bitmap showing the Help Screen, according to a preferred embodiment of the Information Presentation System;

FIG. 9 is a bitmap showing one of the Action Item Screens, according to a preferred embodiment of the Information Presentation System;

FIG. 10 is a bitmap showing the Action Item Status Screen, according to a preferred embodiment of the Information Presentation System;

FIG. 11 is a bitmap showing one of the Worksheet Screens, according to a preferred embodiment of the Information Presentation System;

FIG. 12 is a bitmap showing the Data Menu Screen, according to a preferred embodiment of the Information Presentation System; and

FIG. 13 is a bitmap showing one of the Graph Screens, according to a preferred embodiment of the Information Presentation System.

### DETAILED DESCRIPTION OF A PREFERRED EMBODIMENT

### I. Information Presentation System Hardware and Software

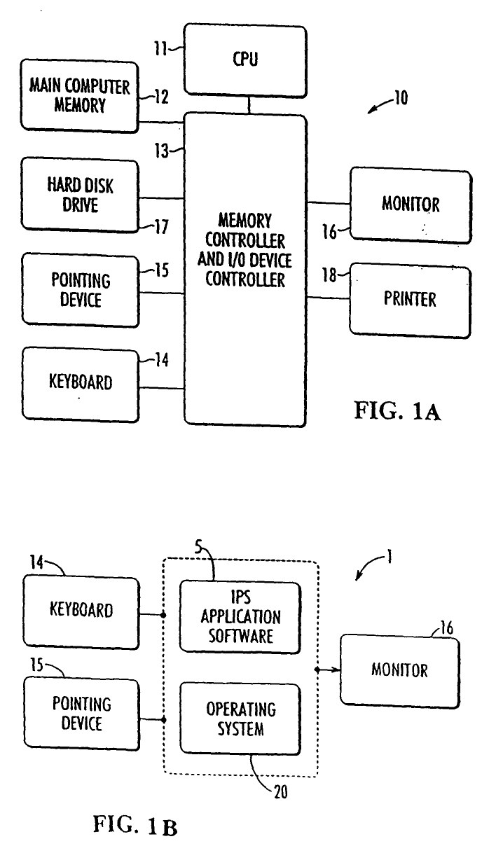

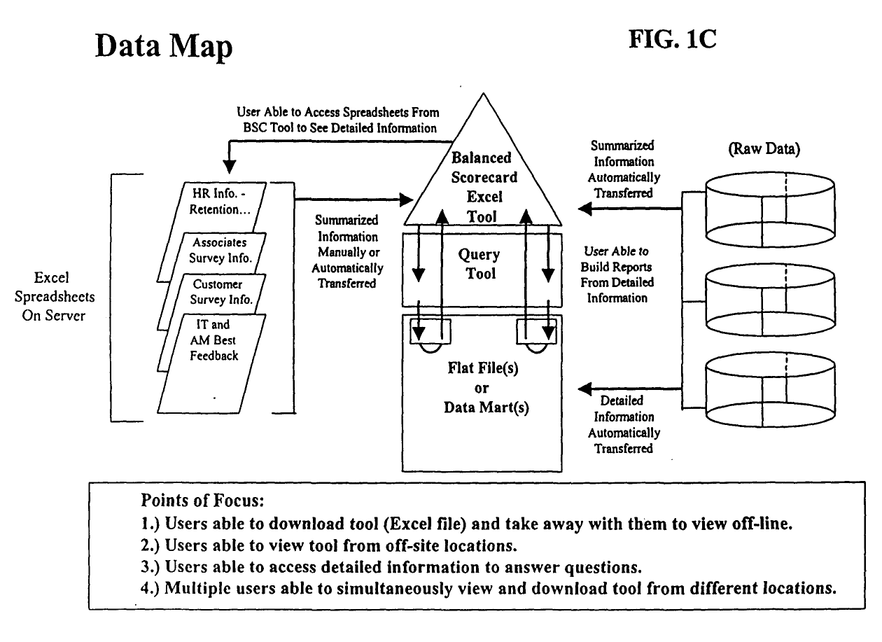

Referring to FIG. 1A, the Information Presentation System 1 of the present invention may be installed or embodied on a computer system such as the computer system 10 shown in FIG. 1A. The computer system 10 can be any standard computer system that is well known in the art, which may be comprised of the following integral parts: a central processing unit 11; a main computer memory 12; a memory and input/output device controller 13; a keyboard 14; a pointing device 15 (e.g., a mechanical computer mouse, i.e., the mouse uses a trackball, an optical mouse, a touch-pad, or some other similar pointing device); a monitor 16 or some other similar display device; a hard disk drive 17 or some other similar memory storage device; and, preferably, a printer 18.

Furthermore, the Information Presentation System 1 can be installed on a computer network server, either a LAN or a WAN, or on any other suitable network, internet and/or intranet configuration, so that the Information Presentation System 1 can be shared by multiple users simultaneously. Additionally, referring to FIG. 1C, the Information Presentation System 1 has a great deal of flexibility in the choice of methods and/or configurations of computer hardware and/or software, which can be used for storing and transferring data, and for inputting the data into the Information Presentation System 1. For example, the data can be manually entered, or imported from databases or from other electronic spreadsheet applications. Related to this, the Information Presentation System 1 can access data marts or flat files through use of the organization's own “query” tools, and the Information Presentation System 1 can access other electronic spreadsheets residing on servers or on other devices that are in communications with the Information Presentation System 1, as shown in FIG. 1C.

Referring now to FIGS. 1A and 1B, a basic block diagram of the Information Presentation System 1 platform is shown. Installed or loaded on the main computer memory 12 and on the hard disk drive 17 memory of the computer system 10 is the operating system 20. The operating system 20 is used to control the operation of the hardware and the software of the computer system 10, thereby, allowing software applications such as the Information Presentation System Application Software 5 to be installed onto the computer system 10 and launched and run by the user when desired. The user enters data, commands, or other similar instructions to the Information Presentation System Application Software 5 and/or the operating system 20 through use of the computer system 10. Preferably the computer operating system 10 is from Microsoft Corporation's Microsoft Windows product line and the Information Presentation System Application Software 5 is from Microsoft Corporation's Microsoft Excel product line.

The Consulting System 2 and/or the Information Presentation System 1 of the present invention are not limited to any specific configuration of devices, operating systems, or electronic spreadsheet software applications. In this regard, those skilled in the art of electronic and/or computer based spreadsheet applications will find that the Consulting System 2 and Information Presentation System 1 (and/or their corresponding methods) may be used with, or complemented or supplemented by, a variety of computer systems, hardware components and/or software applications including, but not limited to, visual basic for macro creation, for example.

Therefore, while the preferred embodiments and the best mode of the present invention are described herein, it should be understood that the best mode for carrying out the invention hereinafter described is by way of illustration and not by way of limitation. It is intended that the scope of the present invention include all modifications that incorporate its principal design features, and that the scope and limitations of the present invention are to be determined by the scope of the appended claims and their equivalents.

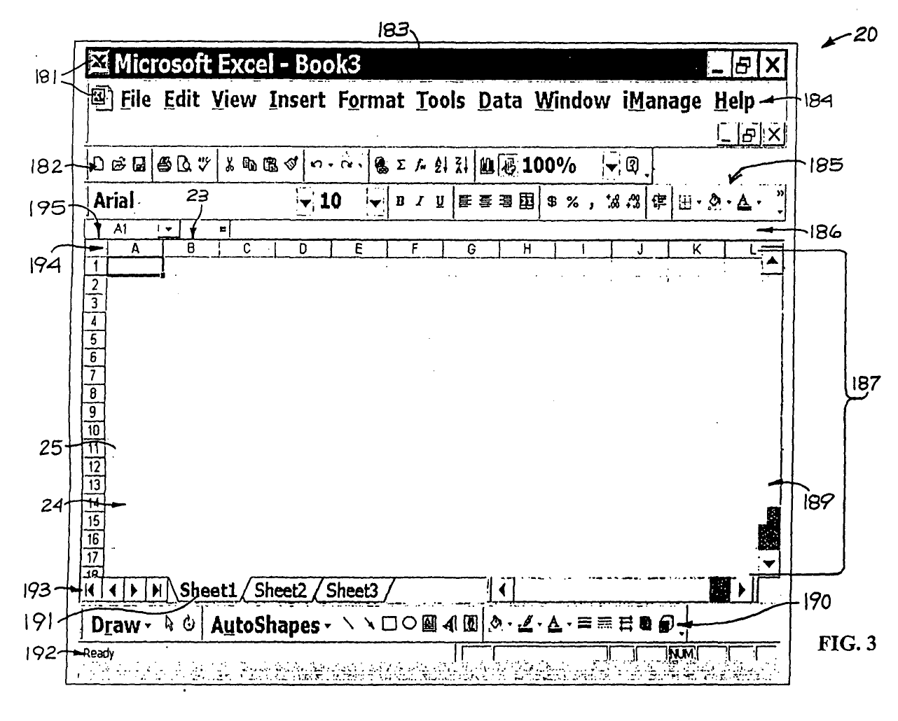

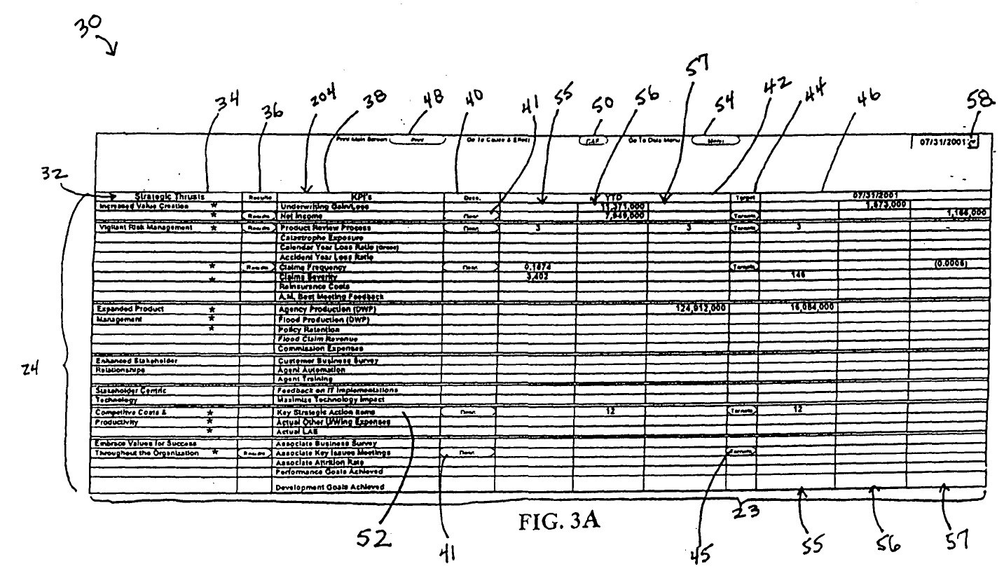

Referring now to FIGS. 1A, 1B, 3 and 3A, since the Information Presentation System 1 uses a spreadsheet software application, i.e., the Information Presentation System Application Software 5, to present the information, it includes most, if not all, of the commonly known attributes of spreadsheet applications, e.g., the screens of the Information Presentation System 1, use the commonly known and used spreadsheet application screen templates 20, as shown in FIG. 3. Preferably, the spreadsheet application screen templates 15 20 are comprised of: control menu icons 181; a Standard Toolbar 182; a Title Bar 183; a Menu Bar 184; a Formatting Toolbar 185; a Formula Bar 186; a Workbook Window 187; a Horizontal Scroll Bar 189; a Text/Graphics Toolbar 190; Sheet Tabs 191; a Status Bar 192; Tab Scrolling Buttons 193; Column Headings 194; Row Headings 195; “columns” 23 (for vertically disposed information); “rows” 24 (for horizontally disposed information); and “cells” 25, which are the information storage and display locations which occur wherever a “column” and a “row” intersect. Generally cells 25 are selected by being “clicked on” by a user through the use of a computer mouse or some other similar pointing device and, once selected, the cell 25 will be highlighted by a darkened border. The cell is generally identified by the intersection of the Column Heading 194 and the Row Heading 195. For example, referring to FIG. 3, the cell 25 with the dark border in the Workbook Window 187 would be identified as cell 25 “A1.” Additionally, the Workbook Window 187 shown in FIG. 3 consists of the rows 24 numbered 1 through 18 and the columns 23 lettered A through L. Therefore, the Workbook Window 187, as shown in FIG. 3, consists of cells 25 A1 through L18. Information can be stored in a cell 25 by first selecting a cell 25 through the use of the keyboard 14 or the pointing device 15 and then manually inputting the information, or it can be “imported” into the cell through the use of cell macros (i.e., software routines or sub-routines that can be used in the Information Presentation System 1). Since the cell macros are computer software code, they can also perform calculations or other manipulations of the information including, but not limited to, inter-cell and/or inter-screen manipulations. Basic spreadsheet program operation and use, including the development and use of spreadsheet macros are well known and disclosed in the literature associated with the art. For example, Element K Content LLC has created a series of Student Manuals for the Microsoft Excel 2000 spreadsheet application that are titled Excel 2000: Worksheets (Final Edition) Millennium Edition, Excel 2000: Charting and Organizing Data (Final Edition) Millennium Edition: and Excel 2000: Advanced (Final Edition) Millennium Edition. All of which bear the copyright notice: © 2001 Element K Content LLC; these manuals are available through the Element K Content LLC website at http://www.elementkpress.com. However, even though the development and use of spreadsheet macros are well known in the art, the macros contained in the present invention are designed by the consultant to perform Information Presentation System 1 specific functions pursuant to the needs and desires of the organization in which it is to be used. Preferably, the spreadsheet screens shown in FIGS. 3A-13 are Workbook Window 187 portions of a Spreadsheet Application Screen Template 20, in other words the spreadsheet screens are embedded in the Workbook Window 187 of a Spreadsheet Application Screen Template 20. Therefore, in operation, whenever the user selects one of the spreadsheet screens, he would not only see the spreadsheet screen, as shown in FIGS. 3A-13 or as modified to meet the user's or the organization's needs, but would also a Spreadsheet Application Screen Template 20.

The Information Presentation System 1, of the present invention, is not just a computer based electronic spreadsheet application, but because it uses a spreadsheet application, which may already be installed on the user's computer system, the following benefits are, or may be, provided by the Information Presentation System 1: costs can be minimized; very quick installation of the Information Presentation System 1 is attainable; the user can be confidant that the organization has the human resources necessary to operate and maintain the Information Presentation System 1; and the spreadsheet applications used with the Information Presentation System 1 have a built-in flexibility for future expansion of the Information Presentation System 1, e.g., the Information Presentation. System 1 allows databases to be added later so that immediate implementation is achievable through less complex configurations.

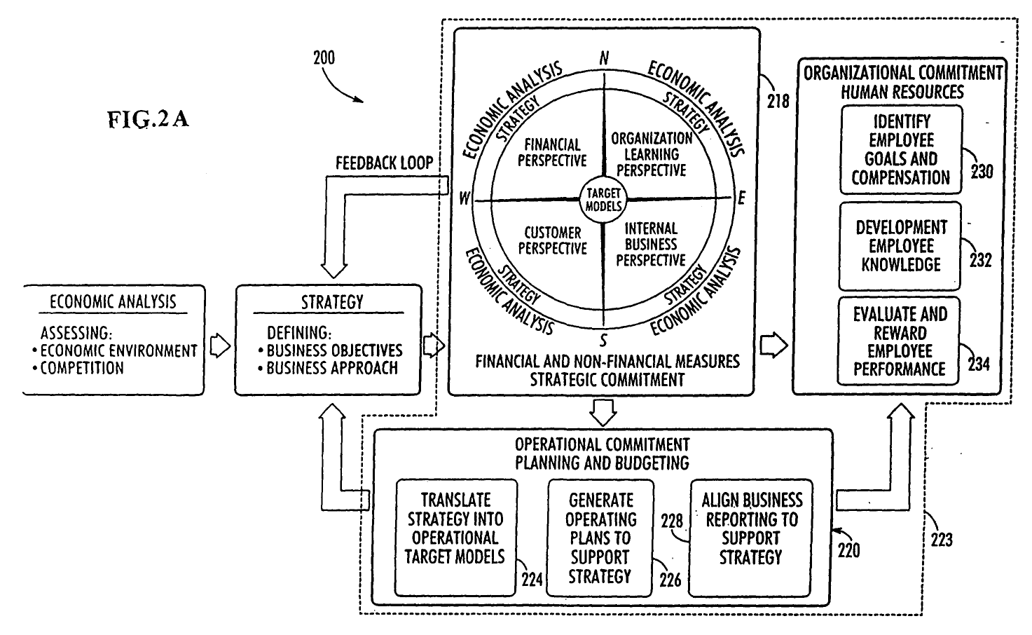

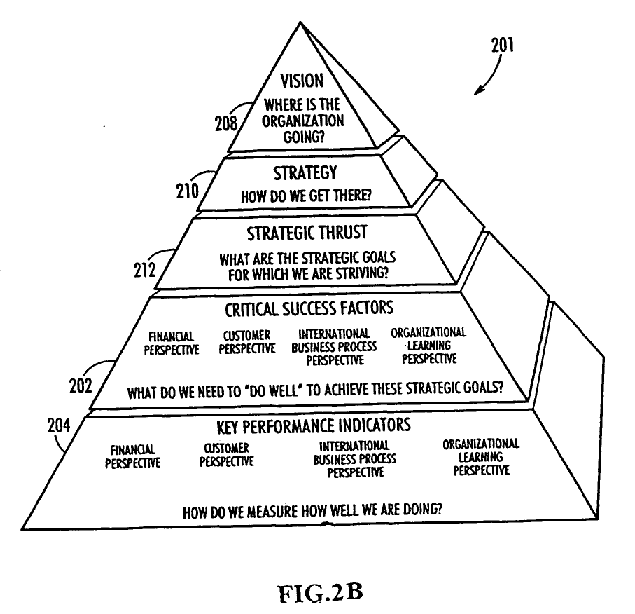

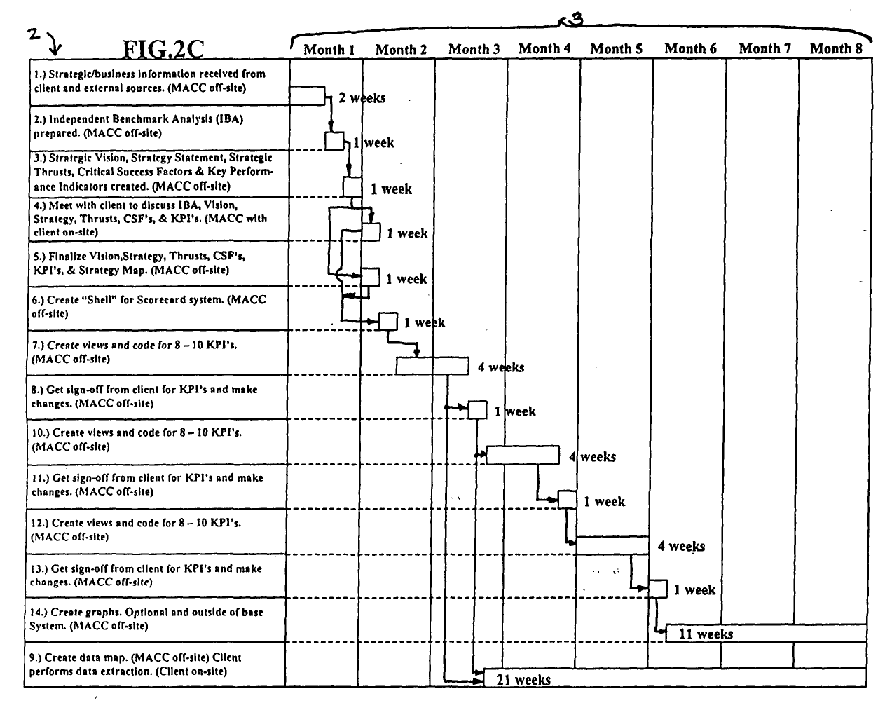

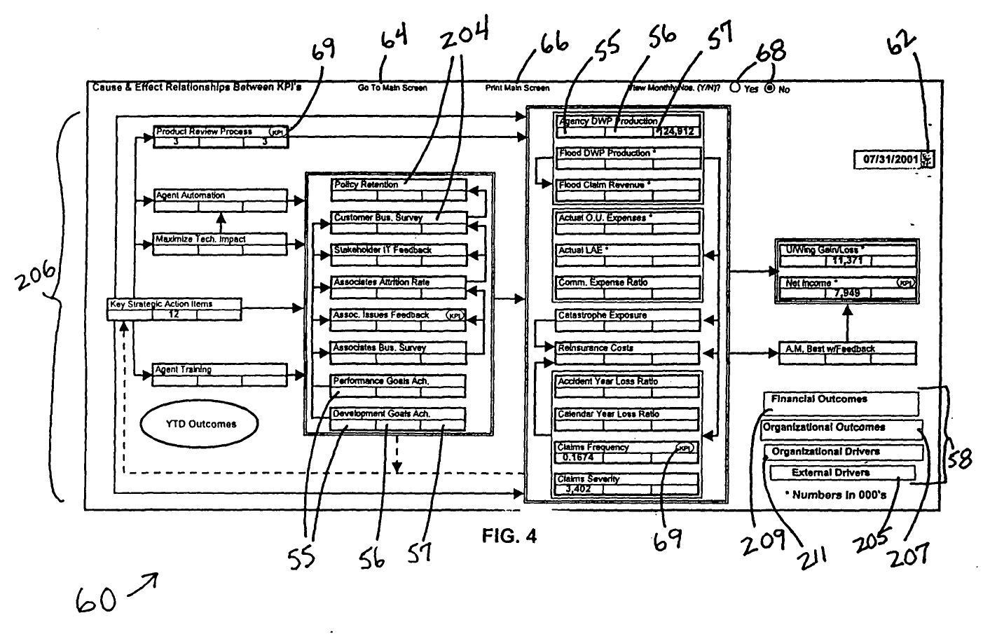

Generally, the Information Presentation System 1 is an organization (e.g., business) management tool that implements a Strategic Organization Plan 200 through use of the Consulting System 2 of the present invention, as shown in FIGS. 2A-C. Referring now to FIGS. 2A-C, the Strategic Organization Plan 200 is based, at least in part, on the Kaplan and Norton “Balanced Business Scorecard” 201 concept The Strategic Organization Plan 200 is comprised of; among other elements, Critical Success Factors, (“CSFs”), 202 which, in order to achieve the Organization's strategic goals, are the areas that the Organization has to excel in, and “Key Performance Indicators, (“KPIs”), 204” which are performance measures that correspond to the CSFs, and should contain a mix of both leading measures of actions and lagging measures of desired outcomes to drive the organization's future performance. The leading measures should be considered as those measures that provide an early indication about whether the strategy being implemented is being implemented successfully; they generally focus the organization on the drivers of future success, i.e., what people should be doing day-by-day to produce successful outcomes in the future; and are also referred to as “performance drivers” because they are indicators of the organization's future performance. Lagging measures, on the other hand, should be viewed as those measures that report results attributable to decisions and actions taken by the organization much earlier, and which generally reveal whether those earlier actions have translated into more business with new and existing customers, and to improved financial performance. Preferably, the consultant tries to achieve a mix of KPIs 204 that consists of about 60% leading measures, and 40% lagging measures to implement the Strategic Organization Plan 200. However, this is not the only mix that can be used and any other mix that is suitable for developing the Strategic Organization Plan 200 for the organization of concern can be used. Once the KPIs 204 and other Strategic Organization Plan 200 [symbol] FIG. 4, of the Information Presentation System 1. This Cause & Effect Screen 60 will display the relationships between the KPIs 204, thereby, showing the dynamics of the organization and, therefore, providing the decision makers of the organization with a very useful and powerful tool. It further clearly delineates between lead and lag KPIs 204 by showing them as External Drivers 205, Organizational Drivers 211, Organizational Outcomes 207 and Financial Outcomes 209 of the organization. Referring now to FIG. 2C, an example of a preferred embodiment of the method steps and system used in the Consulting System 2, and an example of a typical timeline 3 for its implementation are shown.

### II. Strategic Organization Plan Development System and Method

As mentioned, the Balanced Business Scorecard 201 is used as a template to assist in developing the Strategic Organization Plan 200, which is the result of the Consulting System 2 of the present invention. Referring now to FIGS. 2A, the Consulting System 2 and the Strategic Organization Plan 200 are shown. Also related, the development of the Strategic Organization Plan 200 is focused on managing the organization through the five steps of the Balanced Business Scorecard 201, as shown in FIG. 2B. These five steps, as shown, include the identification of: an Organization Vision 208; an Organization Strategy 210; Strategic Thrusts 212; Critical Success Factors 202; and Key Performance Indicators 204. To be able to make these identifications, and in order for a Strategic Organization Plan 200 to be developed through the use of the Consulting System 2, the present invention requires an organization to answer several questions. Where is the organization going, or, perhaps the alternative question, what does the organization want to achieve? How does it get there? What should its strategic goals be? In what areas does it need to excel in order to achieve these goals? And, how does it measure how well it is doing? Additionally, the Consulting System 2 requires these answers to be focused on four critical perspectives: Financial; Customer; Internal Business Processes; and Organizational Learning. The present invention, therefore, uses the Balanced Business Scorecard System 201 as shown in FIG. 2B, to provide information to the Consulting System 2, as shown in FIG. 2A. To assemble and then assimilate this and other necessary information, the Consulting System 2 requires the consultant, who will be developing the Strategic Organization Plan 200 in coordination with the organization, to perform an analysis of a organization's current strategic organization plan, if one is in place, and of the organization's documents and records, as well as publicly available external data. This analysis will include an assessment of the organization's economic environment and, if appropriate, its competition, and this analysis will be used to define the organization's objectives, and the choice of the strategic approach the organization should use to excel, i.e., price, product diversification, and/or quality—with the caveat that the organization should only pick one in which to excel and be competitive in the other two. Additionally, the assessment will be used by the consultant to develop a proposed Organization Vision 208 statement, the Organization Strategy 210, the Strategic Thrusts 212, the CSFs 202, and the KPIs 204. With respect to the KPIs 204, the KPIs 204 are developed in order to create and facilitate the organization's Strategic Commitment 218 and they are linked to the Planning & Budgeting and Human Resource functions. By linking the KPIs 204 to the organization's Planning & Budgeting Process Operational Commitment 220 is achieved, and by linking the KPI's 204 to the organization's Human Resource functions Organizational Commitment 222 is achieved. Broadly stated, the obtaining of Strategic Commitment 218, Operational Commitment 220, and Organizational Commitment 222, create Performance Commitment 223 for the entire organization. Based on this, Performance Commitment 223 for the organization should be viewed as an organizational state wherein the employees are enabled to perform to the standards set by the Strategic Organization Plan 200, and the employees are committed to using the resources of the organization to support the Plan 200. During the development of the Performance Commitment 223, i.e., during the consultation phase, not only will a determination be made as to which KPIs 204 should be used to track organization's performance, but the assessment will also consider and determine the analytical depth that should be used by the organization and, therefore, made available by the Information Presentation System 1 to track such performance. Generally stated, increasing analytical depth requires the development of an increasing number of user accessible “drill down” screens in the Information Presentation System 1. To “drill down” is to move from more general data, e.g., summary information, to the more detailed data that was used to create the general information, e.g., data worksheets.

As previously mentioned and more specifically, an additional feature of the Strategic Organization Plan 200 and, therefore, the Consulting System 2, is the linkage between the Strategic Commitment 218 and the Operational Commitment 220, i.e., the Planning & Budgeting processes and/or functions of the organization. This is accomplished by translating business strategy into Operational Target Models 224, by generating Operating Plans 226, and by aligning the Organization's Reporting 228 so that the Operational Commitment 220 supports the Strategic Commitment 218 and, therefore, the Performance Commitment 223 portion of the Strategic Organization Plan 200. By focusing on this linkage between the Strategic Commitment 218 and the Operational Commitment 220, the present invention ensures the resources of the organization are allocated and used in support of the Strategic Organization Plan 200.

Another additional feature, in conjunction with this, is the linkage between the Strategic Commitment 218 and the Organizational Commitment 222, i.e., the Human Resources function of the organization, to ensure that the employees' goals, actions, and rewards are linked to the Strategic Commitment 218. This linkage requires that the Employee Goals and Compensation 230, the Development of Employee Knowledge 232, and programs that Evaluate and Reward Employee Performance 234, are identified and incorporated into the Strategic Organization Plan 200 so that the Organizational Commitment 222 will support the Strategic Commitment 218 and, therefore, the Performance Commitment 223 portion of the Strategic Organization Plan 200. Because of these Consulting System 2 and Strategic Organization Plan 200 linkages, the enabling of the Performance Commitment 223 and, therefore, the Strategic Organization Plan 200 is promoted and, therefore, the likelihood of its possible success is increased.

As a result of this Consulting System 2 analysis, a Strategic Organization Plan 200, containing a description of the organization's Strategic Commitment 218, Operational Commitment 220 and Organizational Commitment 222 will be developed and ready for subsequent implementation through the organization's use of the Information Presentation System 1 of the present invention.

An important aspect of the Consulting System 2 is the use of a “feedback loop” and “two-way” flow paths between the elements as shown in FIG. 2A. This allows the Consulting System 2 to be flexible in its development and in its use.

Another important aspect of the Consulting System 2 is that a substantial portion of the Strategic Organization Plan's 200 development is accomplished by using the organization's current documents and policies, as well as publicly available external data, and only requires limited consultation time with the leadership or senior management of the organization, which, preferably, may be the only human resources of the organization that are used by the consultant in developing the Strategic Organization Plan 200. As a result, the consultant is provided with an opportunity to develop a substantial portion of the Strategic Organization,Plan without requiring a substantial amount of the organization's resources. This allows the Consulting System 2 consultant the opportunity to come to the organization highly focused, which generally results in the organization's review and approval of the Strategic Organization Plan 200 and the Consulting System's 2 analysis and assessment in a very short amount of time, and which fosters an additional opportunity to realize the time-savings associated with the subsequent installation and implementation of the Strategic Organization Plan 200 through the use of the Information Presentation System 1.

An additional very important feature of the Consulting System 2 of the present invention is the consultant's use of color-coding in the Strategic Organization Plan 200, as part of the presentation of the Strategic Organization Plan 200 to the organization for its review and approval. After the consultant has formulated the Strategic Vision 208 and the Strategy 210 statement, the Applicant has found that the review and approval process, associated with the Strategic Organization Plan 200, is facilitated by inter-relating the Strategic Thrusts 212, the Critical Success Factors 202, and the KPIs 204 through the use of color-coding, i.e., by using the same font color for all related items. For example, assume that one of the Strategic Thrusts 212 is “Increased Value Creation,” then each Critical Success Factor 202 associated with “Increased Value Creation” will also be shown in red and all KPIs 204 associated with the those Critical Success Factors 202 will also be shown in red. Furthermore, all other documents included in or associated with the Strategic Organization Plan 200 will also be formatted to maintain this color-coding scheme.

Note, however, that this color-coding is a separate element of the Consulting System 2 and should not be confused with the color-coding that will be described as an element of the Information Presentation System 1 below. This allows for customization of the Information Presentation System 1 to meet the client's needs.

### III. Information Presentation System

A. Introduction:

The following description of the preferred embodiments of the present invention is based on the Microsoft Excel spreadsheet application operating on a Microsoft Windows operating system; both of which are available from the Microsoft Corporation of Redmond, Wash. The present invention, however, is not limited to any particular application or to any particular operating system. In this regard, those skilled in the art of electronic and/or computer based spreadsheet applications will find that the system and methods of the present invention may be used with a variety of systems and software applications. Furthermore, the configurations of the present invention are not limited to those shown in the figures or as described herein in that the present invention can be customized and/or modified to meet the needs of the user and/or organization, as appropriate and/or as desired. Therefore, the preferred embodiments and the best mode of the present invention are described herein. However, it should be understood that the best mode for carrying out the invention hereinafter described is by way of illustration and not by way of limitation. It is intended that the scope of the present invention include all modifications that incorporate its principal design features, and that the scope and limitations of the present invention are to be determined by the scope of the appended claims and their equivalents.

In the following discussion of the Information Presentation System 1, one of the predominant features of the Information Presentation System 1 is the use of navigational buttons. These buttons are created during the development of the Information Presentation System 1 and are used to allow for total utilization of the capacity of the electronic spreadsheets, the electronic spreadsheet application, and for overall ease of use of the Information Presentation System 1. Furthermore, the use of organization notes, embedded within the electronic spreadsheet screens, is another predominant feature of the present invention.

B. Screens:

The screens 30, 60, 70, 90, 100, 110, 120, 130, 140, 150, 160, and 170 of the present invention are electronic spreadsheets, such as Excel “worksheets.”

Main Screen 30:

Referring now to FIG. 3A, Main Screen 30 is shown A row of headings 32 are used to describe what appears in the columns associated with each heading. The heading of the first column is usually Strategic Thrusts, Critical Success Factors, or Balanced Scorecard Perspectives 34, and the headings for the remaining columns are: Results 36; KPIs 38, which is the acronym for Key Performance Indicators 204; Desc. 40, which is an abbreviation for Description; YTD Results 42, which is a shortened version of Year-To-Date Results; Targets 44; and a user selected Reporting Period 46.

The items entered under, or the information linked to, the buttons under the headings of Strategic Thrusts 34, Results 36, KPIs 38, Desc. 40, and Targets 44 are information and/or items that have been determined during the Consulting System 2 phase of the present invention, or have been modified by the user since development to reflect changes in the user's Strategic, Organization Plan 200.. Preferably, three color-coded columns are associated with YTD Results 42, and the user selected Reporting Period 46. Preferably, the three colors selected for the three color-coded columns are Red 55, Yellow 56, and Green 57; with Green 57 indicating that the item being displayed in that color-coded column is meeting or exceeding “plan”; with Yellow 56 indicating that the item being displayed in that color-coded column is “off-plan” but within the acceptable variance; and with Red 55 indicating that the item being displayed in that color-coded column is “off-plan” and beyond the acceptable variance. The “plan” amount or values are projections of what the organization and/or consultant predicts the KPI 204 should be at a certain time, while the “variance” from such amount or value are what the organization and/or the consultant determines is an acceptable deviation from that amount or value—both of these are originally determined during the Consulting System 2 phase of the present invention. The Reporting Period 46 is user selected and it can be daily, weekly, monthly, quarterly, semi-annually, or annually. The Print Button 48, if selected, allows a copy of the Main Screen 30 to be printed out at the printer (not shown) that the user's computer, running the present invention, is attached to. The C & E button 50, if selected, allows the user to be linked to the Cause & Effect Screen 60, which shows the cause and effect relationships between the Key Performance Indicators 204, a list of which are entered in the KPIs 38 column. The Data Button 54, if selected, will link the user (and/or the system administrator) to where the Information Presentation System 1 data (i.e., KPI 204 data) resides in spreadsheet form via the Data Menu Screen 160. The Main Screen Drop Down Box 56, if selected, allows the user to change the user selected Reporting Period 46, currently selected and displayed on Main Screen 30, to another Reporting Period. If any of the Results Buttons 37, under the Results 36 heading, are selected, the user will be linked to the “first level drill down,” the KPI Results Screen 90, which will display the results of the KPI 204 associated with the selected Results Button 37. If any of the Desc. Buttons 41, under the Desc. 40 heading, are selected, the user will be linked to a Description Screen 60, which will display a description and an explanation of why the KPI 204 associated with the selected Desc. Button 41 is important to the user's organization. If any of the Targets Buttons 45, under the Targets 44 heading, are selected, the user will be linked to a Targets Screen 140 that contains a listing of the “targets” and the “variance” for the KPI 204 that is associated with the Targets Button 45 that was selected. Additionally, if the user allows the cursor to stop on one of the KPI cells under the KPIs 38 heading, then a comment box will appear that will display pertinent information about the KPI 204 listed in that KPI cell. The Menu Screen 30 may also have other navigational buttons installed including, but not limited to a Display Button (not shown), which could, for example, allow the user to change the current computer display settings, or which could allow the user to revert back to prior display settings.

Cause & Effect Screen 60:

Referring now to FIG. 4, the Cause & Effect Screen 60, displays each KPI 204 along with its year-to-date or its monthly result in a red 55, a yellow 56, or a green 57 box, and, through the use of visual indicators, e.g., arrows, also displays the relationships between the KPIs 204, thereby, showing the dynamics of the organization. If the KPI 204 result is displayed in: a green 57 box, then it is meeting or exceeding plan; a yellow 56 box, then it is off plan, but it is within an acceptable variance; a red 55 box, then the result is off plan and it is beyond the acceptable variance. This color-coding convention is used throughout the Information Presentation System 1 whenever reporting period results are displayed. Also the KPIs 204 may be visually represented as either lead and or lag measures by, for example, color-coding the border around each KPI 204 according to a color-coded legend that could be displayed in this or on any of the other screens, (not shown). Also, the KPIs 204 could be displayed according to whether they are External Drivers 205 of the company, an Organizational Driver 211, an Organizational Outcome 207 of the company, or a Financial Outcome 209 of the company. This could be defined, for example, by color-coding the cells of the box 58, which is shown in the lower right-hand corner of this screen.

The Cause & Effect Screen Drop Down Box 62, if selected, allows the user to enter a date, which will allow the user to view the results extant on the date entered. The Cause & Effect Screen Main Screen Button 64, if selected, allows the user to link back to the Main Screen 30. The Cause & Effect Screen Print Button 66, if selected, allows a copy of the Cause & Effect Screen 60 to be printed out at the printer (not shown) that the user's computer, running the present invention, is attached to. The Radio Buttons 68 allow the user to choose between viewing monthly results or year-to-date results. If any of the Cause & Effect Screen KPI buttons 69, are selected, the user will be linked to the KPI Results Screen 70 corresponding to the KPI 204 that is associated with the KPI button 69 selected.

KPI Results Screen 70:

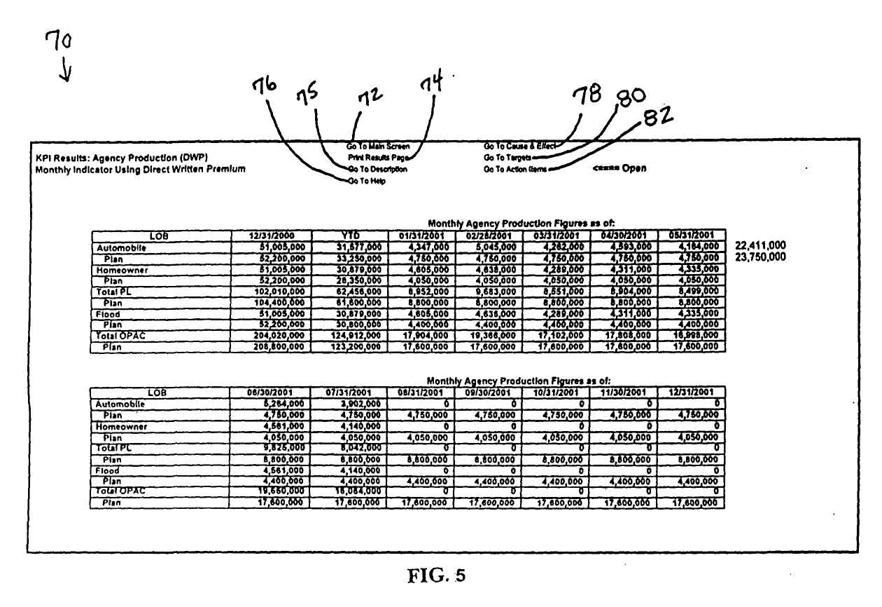

FIG. 5 shows an example of one of the KPI Results Screens 70. Associated with each KPI 204 (i.e., Key Performance Indicator) is a KPI Results Screen 70 that will display detailed information on the KPI 204 associated with the KPI Results Screen 70 selected by the user. The user is linked to a specific KPI Results Screen 70 by selecting the associated KPI Results Button 37 on the Main Screen 30. The user may also access the KPI Results Screen 70 by selecting the appropriate button on the Help Screen 110, the Description Screen 90, the Targets Screen 100, the Action Items Screen 120, the Worksheet Screen 150, and/or the Graph Screen 170.

If the KPI Results Screen Main Screen Button 72 is selected, the user is linked back to the Main Screen 30. Selecting the KPI Results Screen Print Button 74 allows a copy of the KPI Results Screen 70, which the user is currently viewing, to be printed out at the printer (not shown) that the user's computer, running the present invention, is attached to. Selecting the KPI Results Screen Description Screen Button 75 links the user to a Description Screen 90 that will provide the user with information explaining why the selected KPI 204 is important to the user's organization. Selecting the KPI Results Screen Help Button 76 links the user to a Help Screen 110 that will provide the user with assistance information concerning the KPI 204 being viewed and, possibly, the Information Presentation System 1. Selecting the KPI Results Screen C & E Button 78 links the user to the Cause & Effect Screen 60. Selecting the KPI Results Screen Targets Button 80 links the user to the Targets Screen 100 associated with the KPI 204 that is being viewed, and will provide the user with information concerning the targets and the variance that are used to establish the color, e.g., red 55, yellow 56 or green 57, that will be used to color the block in which the KPI result is being displayed, i.e., continuing with the color-coding convention that is used throughout the Information Presentation System 1, a KPI result is displayed as being in a specifically colored block according to how the actual KPI result compares with plan targets and the variance for that KPI result. Selecting the KPI Results Screen Action Item Button 82 links the user to the Action Item Screen 120 for the KPI 204 being viewed. This is an executive diary system for tracking each of the KPI strategic action items assigned by management. The KPI Results Screen 70 can be configured to show various reporting periods simultaneously. Selecting a KPI Results Screen Graph Button, if one has been formatted for use with the KPI Results Screen 70 being viewed (not shown), the user could be linked to a screen that displays a graphical representation of the same results shown on the KPI Results Screen 70 being viewed. Accordingly, other navigational buttons can be formatted for use on this and any of the other screens. For example, a KPI Results Screen Sheet Button can be created to link the user to a Worksheet Screen 150 that displays the figures and plan numbers associated with the KPI 204 of concern. Also, monthly and YTD results can be displayed simultaneously if desired.

Description Screen 90:

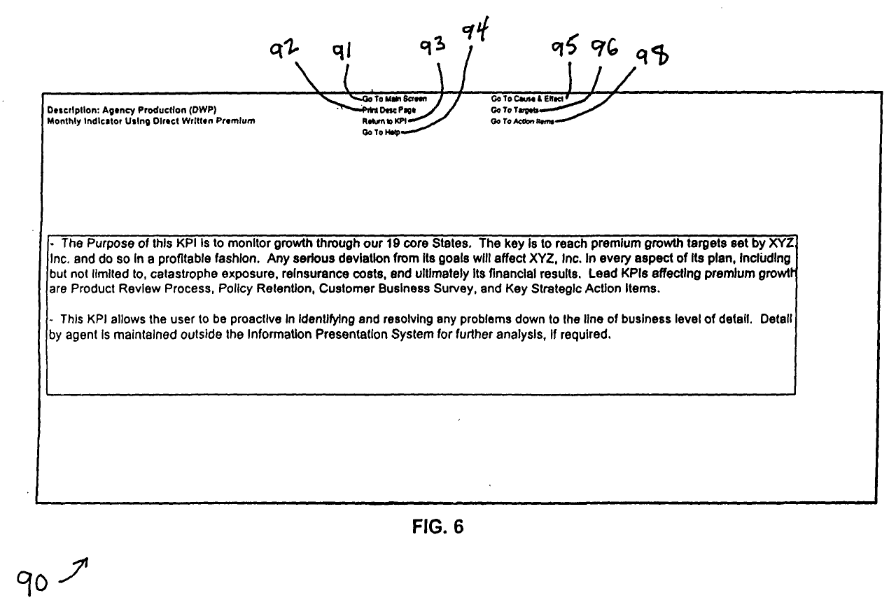

FIG. 6 shows an example of one of the Description Screens 90. Each Description Screen 90 displays information, associated with a corresponding KPI 204, that communicates to the user why a selected KPI 204 is important to the user's organization. The user can be linked to a Description Screen 90 either by selecting one of the Desc. Buttons 41 on the Main Screen 30, or by selecting one of the KPI Results Screens' Description Screen Buttons 75. The user can also access the Description Screen 90 by selecting the appropriate button on the Help Screen 110, the Targets Screen 100, and/or the Action Items Screen 120.

If the Description Screen Main Screen Button 91 is selected, the user is linked back to the Main Screen 30. Selecting the Description Screen Print Button 92 allows a copy of the Description Screen 90, which the user is currently viewing, to be printed out at the printer (not shown) that the user's computer, running the present invention, is attached to. Selecting the Return to KPI Button 93 links the user to the KPI Results Screen 70 associated with the KPI 204 being viewed. Selecting the Description Screen Help Button 94 links the user to a Help Screen 110 that will provide the user with assistance information concerning the KPI 204 being viewed and, possibly, the Information Presentation System 1. Selecting the Description Screen Cause & Effect Button 95 links the user to the Cause & Effect Screen 60. Selecting the Description Screen Targets Button 96 links the user to the Targets Screen 100 associated with the KPI 204 that is being viewed. Selecting the Description Screen Action Item Button 98 links the user to the Action Item Screen 120 for the KPI 204 being viewed.

Targets Screen 100:

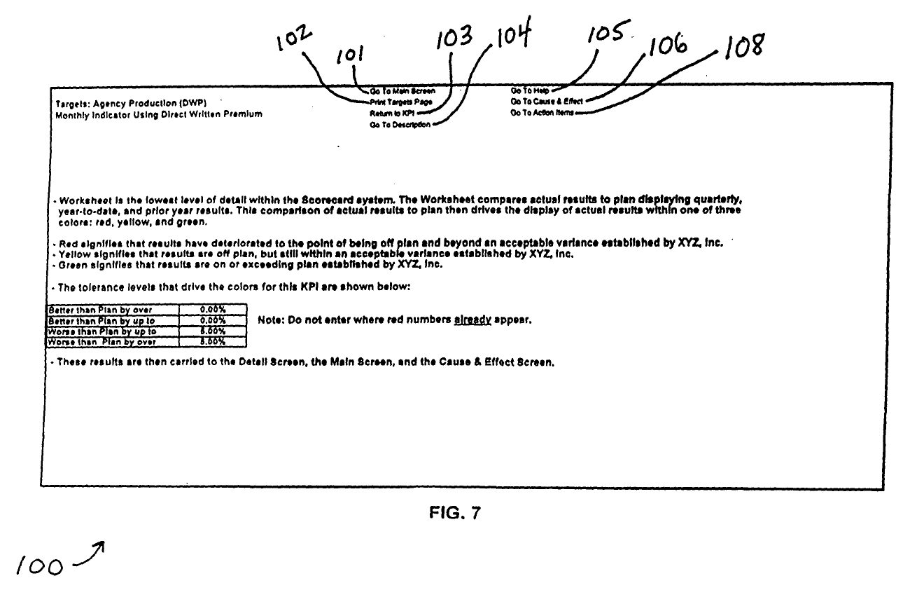

FIG. 7 shows an example of one of the Targets Screens 100. Each Targets Screen 100 displays information associated with a corresponding KPI 204 that communicates to the user what the thresholds are for the KPI 204 being viewed and where a KPI result 204 will be listed in accordance with the color-coding convention of the Information Presentation System 1. The user is linked to a Targets Screen 100 either by selecting one of the KPI Results Screen Targets Buttons 80 or by selecting one of the Targets Buttons 45 on the Main Screen 30. From this Targets Screen 100, the user can change the threshold values and the variance for the KPI 204 being viewed by manually inputting these changes' into the appropriate cells. These changes will determine, for the KPI 204 being viewed, which color-coded column and/or which color is used for the block, the KPI 204 result is displayed in, and these changes may be applied to the corresponding KPI Results Screen 70, the Detail Screen (if any), a Worksheet Screen 150, the Main Screen 30, the Cause & Effect Screen 70, and/or the Graph Screen 170. The user can be linked to the Targets Screen 100 by selecting the appropriate button on the Help 110, the Description Screen 90, and/or the Action Items Screen 120.

If the Targets Screen Main Screen Button 101 is selected, the user is linked back to the Main Screen 30. Selecting the Targets Screen Print Button 102 allows a copy of the Targets Screen 100, which the user is currently viewing, to be printed out at the printer (not shown) that the user's computer, running the present invention, is attached to. Selecting the Targets Screen Return to KPI Button 103 links the user to the KPI Results Screen 70 associated with the KPI 204 being viewed. Selecting the Targets Screen Description Screen Button 104 links the user to a Description Screen 90 that will provide the user with information explaining why the selected KPI 204 is important to the user's organization. Selecting the Targets Screen Help Button 105 links the user to a Help Screen 110 that will provide the user with assistance information concerning the KPI 204 being viewed and, possibly, the Information Presentation System 1. Selecting the Targets Screen Cause & Effect Button 106 links the user to the Cause & Effect Screen 60. Selecting the Targets Screen Action Item Button 108 links the user to the Action Items Screen 120 for the KPI 204 being viewed.

Help Screen 110:

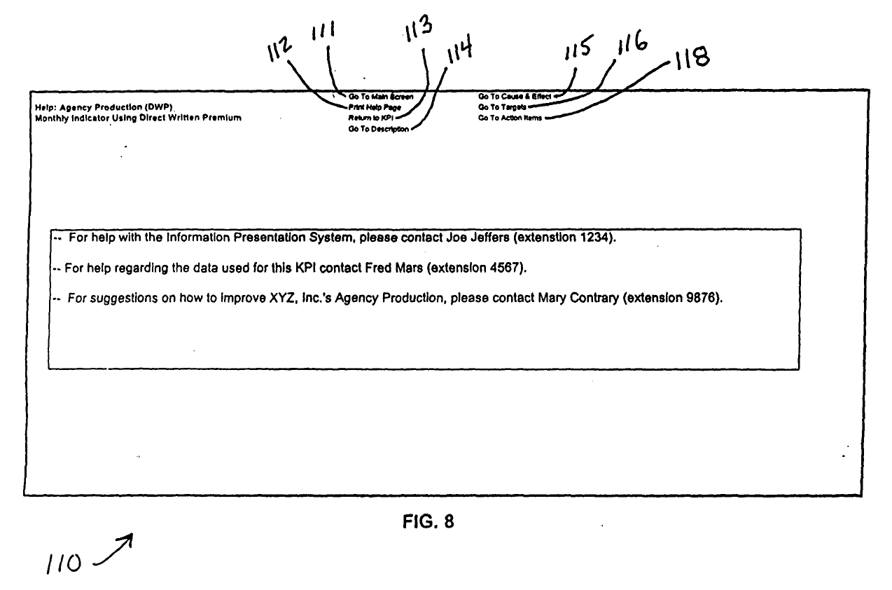

FIG. 8 shows an example of one of the Help Screens 110. EachHelp Screen 110 displays information, associated with a corresponding KPI 204, that communicates to the user where the user can go to obtain help for the KPI 204 being viewed and/or for the Information Presentation System 1. The user is linked to a Help Screen 110 by selecting one of KPI Results Screen Help Buttons 76. The used can also access the Help Screen 110 by selecting the appropriate button on the Description Screen 90, the Targets Screen 100, and/or the Action Items Screen 120.

If the Help Screen Main Screen Button 111 is selected, the user is linked back to the Main Screen 30. Selecting the Help Screen Print Button 112 allows a copy of the Help Screen 110, which the user is currently viewing, to be printed out at the printer (not shown) that the user's computer, running the present invention, is attached to. Selecting the Help Screen Return to KPI Button 113 links the user to the KPI Results Screen 70 associated with the KPI 204 being viewed. Selecting the Help Screen Description Screen Button 114 links the user to a Description Screen 90 that will provide the user with information explaining why the selected KPI 204 is important to the user's organization. Selecting the Help Screen Cause & Effect Button 115 links the user to the Cause & Effect Screen 60. Selecting the Help Screen Targets Button 116 links the user to the Targets Screen 100 associated with the KPI 204 that is being viewed. Selecting the Help Screen Action Item Button 118 links the user to the Action Item Screen 120 for the KPI 204 being viewed.

Action Item Screen 120:

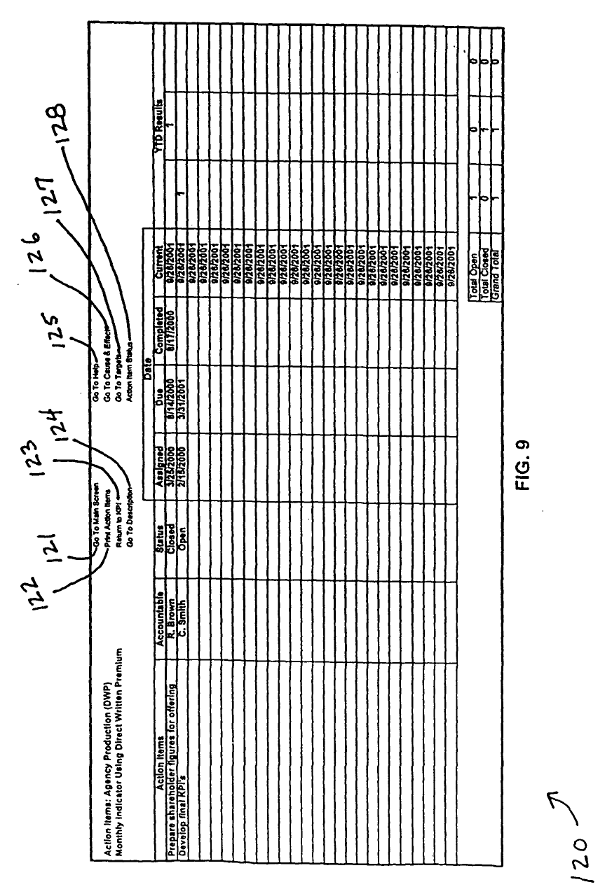

FIG. 9 shows an example of one of the Action Item Screens 120. EachAction Item Screen 120 provides the user with information regarding the status of the strategic action items associated with a corresponding KPI 204. The user is linked to an Action Item Screen 120 by selecting one of: the KPI Results Screens Action Item Buttons 82; the Description Screens Action Item Buttons 98; the Help Screens Action Item Buttons 118; the Targets Screens Action Item Buttons 108; or the Action Item Status Screen Action Item Buttons 138. Each Action Item Screen 120 is designed to be in an Executive Diary System format; whereby, the user is able to view the status of each strategic action item that is associated with a selected KPI 204. Each Action Item Screen 120 displays information, associated with a corresponding KPI 204, in accordance with the Information Presentation System's 1 color-coding convention. If the Action Item Screen Main Screen Button 121 is selected, the user is linked back to the Main Screen 30. Selecting the Action Item Screen Print Button 122 allows a copy of the Action Item Screen 120, which the user is currently viewing, to be printed out at the printer (not shown) that the user's computer, running the present invention, is attached to.

Selecting the Action Item Screen Return to KPI Button 123 links the user to the KPI Results Screen 70 associated with the KPI 204 being viewed. Selecting the Action Item Screen Description Screen Button 124 links the user to a Description Screen 90 that will provide the user with information explaining why the selected KPI 204 is important to the user's organization. Selecting the Action Item Screen Help Button 125 links the user to a Help Screen 110 that will provide the user with assistance information concerning the KPI 204 being viewed and possibly the Information Presentation System 1. Selecting the Action Item Screen Cause & Effect Button 126 links the user to the Cause & Effect Screen 60. Selecting the Action Item Screen Targets Screen Button 127 links the user to the Targets Screen 100 associated with the KPI 204 that is being viewed. Selecting the Action Item Screen Action Item Status Screen Button 128 links the user to the Action Item Status Screen 130 containing the status of Strategic Action Items associated with all of the KPIs 204.

Action Item Status Screen 130:

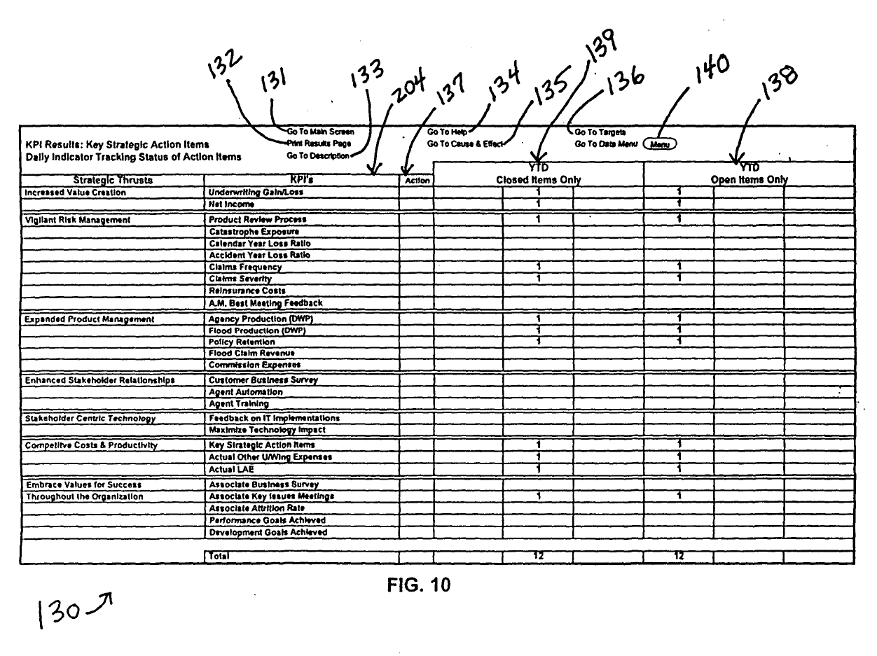

FIG. 10 shows the Action Item Status Screen 130. The Action Item Status Screen 130 is designed in an Executive Diary format, and it is used to provide information to the user regarding the status of all of the strategic action items associated with allof the KPIs 204. The user is linked to the Action Item Status Screen 130 by selecting one of the Action Item Screen's Action Item Status Screen Buttons 128 or by selecting the Key Strategic Action Items cell 52 on the Main Screen 30. The Action Item Status Screen 130 displays status information in accordance with the color-coding convention of the Information PresentationSystem 1.

If the Action Item Status Screen Main Screen Button 131 is selected, the user is linked back to the Main Screen 30. Selecting the Action Item Status Screen Print Button 132 allows a copy of the Action Item Status Screen 130 to be printed out at the printer (not shown) that the user's computer, running the present invention, is attached to. Selecting the Action Item Status Screen Description Screen Button 133 links the user to a Description Screen 90 that will provide the user with information explaining why the selected KPI 204 is important to the user's organization. Selecting the Action Item Status Screen Help Button 134 links the user to a Help Screen 110 that will provide the user with assistance information regarding the Information Presentation System 1. Selecting the Action Item Status Screen Cause & Effect Button 135 links the user to the Cause & Effect Screen 60. Selecting the Action Item Status Screen Targets Screen Button 136 links the user to the Targets Screen 100 associated with the KPI 204 that is selected. Selecting one of the Action Item Status Screen Action Item Screen Buttons 137 will link the user to the Action Item Screen 120 associated with the KPI 204 that corresponds to the Action Item Status Screen Action Item Status Screen Button 137 that is selected. The Open Action Items 138 and the Closed Action Items 139 sections of the Action Item Status Screen display the status of the Open Action Items and the Closed Action Items in their respective sections. Selecting the Data Menu button 140 links the user to the Data Menu Screen 160.

Worksheet Screen 150:

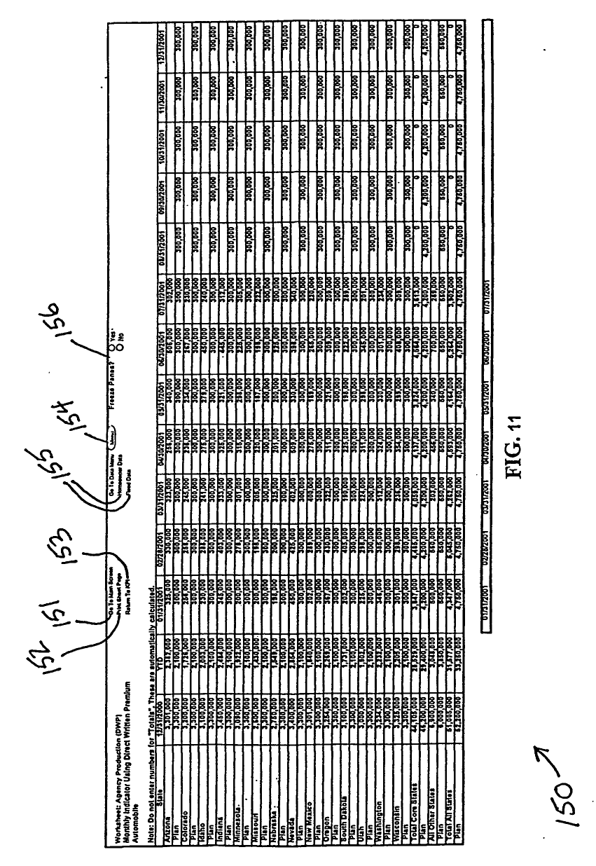

FIG. 11 shows an example of one of the KPI Worksheet Screens 150. Each Worksheet Screen 150 displays the actual results or data associated with the KPI 204 that corresponds to the Worksheet Screen 150 being viewed, and allows the user to compare those results with plan targets, which are also displayed on the same Worksheet Screen 150. The actual KPI 204 data or results can be imported from data tables, or the data and results can be directly input into the sheet being viewed. The listing of the KPI 204 results in accordance with the Information Presentation System's 1 color-coding convention are driven by the data and results input to and shown on the Worksheet Screens 150. Consequently, if the KPI 204 data or results on the Worksheet Screen 150 being viewed are changed, then the data and results for that KPI 204 will be changed on all of the associated screens. The Worksheet Screen150 also displays prior years data The user can be linked to a Worksheet Screen 150 by selecting the KPI Results Screen Sheet Button 88 associated with a KPI 204 of interest.

If the Worksheet Screen Main Screen Button 151 is selected, the user is linked back to the Main Screen 30. Selecting the Worksheet Screen Print Button 152 allows a copy of the Worksheet Screen 150, which the user is currently viewing, to be printed out at the printer (not shown) that the user's computer, running the present invention, is attached to. Selecting the Worksheet Screen Return to KPI Button 153 links the user to the KPI Results Screen 70 associated with the KPI 204 being viewed. Selecting the Worksheet Screen Data Menu Button 154 links the user to the Data Menu Screen 160, and selecting an optional Sub-Worksheet Screen Button 155 links the user to more detailed worksheets, which are used to derive the numbers shown on the Worksheet Screen 150. Selecting the Freeze Panes Button 156 allows the user to freeze and unfreeze rows 24 and columns 23 for easy navigation when data exceeds the size of the computer screen. Other navigational buttons may also be created including, but not limited to a Worksheet Screen Graph Button, which could link the user to a screen that displays a graphical representation of the same results shown on the Worksheet Screen 90 for the KPI 204 being viewed; a Worksheet Screen Drop Down Box, which could allow the user to change the user selected reporting period date currently selected and displayed on the Worksheet Screen 150 being viewed.

Data Menu Screen 160:

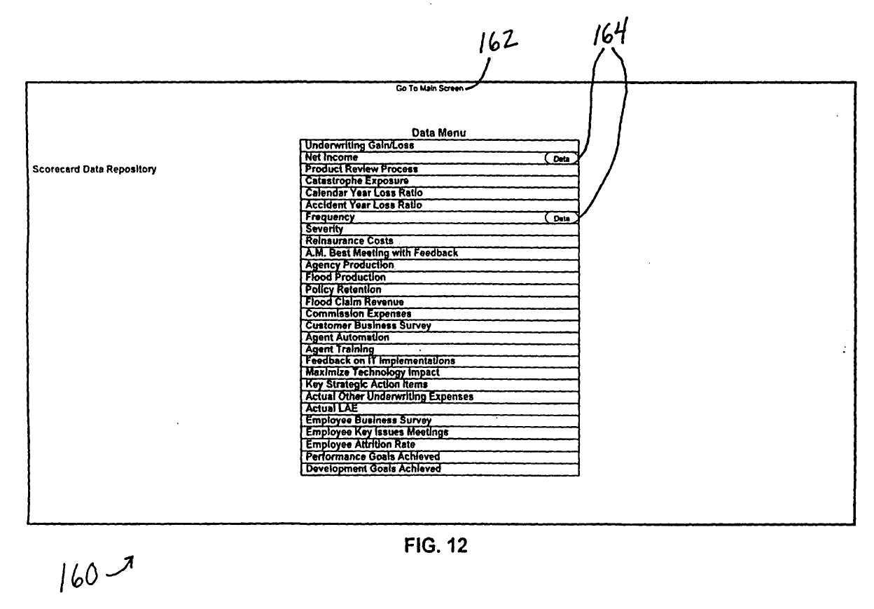

FIG. 12 shows the Data Menu Screen 160. The Data Menu Screen 160displays a menu that allows the user to access the data for each KPI 204. The data selected by the user is shown in spreadsheet form within a spreadsheet application that the user is comfortable using and manipulating, which permits ease of accessibility and usability. Additionally, since the data can easily be inserted into the Information Presentation System 1 by “copying and pasting” the data from the user's organization's own current databases, by manually inputting the data, or by inputting data from other data repositories, rapid screen development and, therefore, rapid installation of the Information Presentation System 1 is promoted.

Selecting the Data Menu Screen Main Screen Button 162 links the user to the Main Screen 30. Selecting the Data Menu Screen Data Button 164 links the user to the KPI data Worksheet Screen 150 selected by the user.

Graph Screen 170:

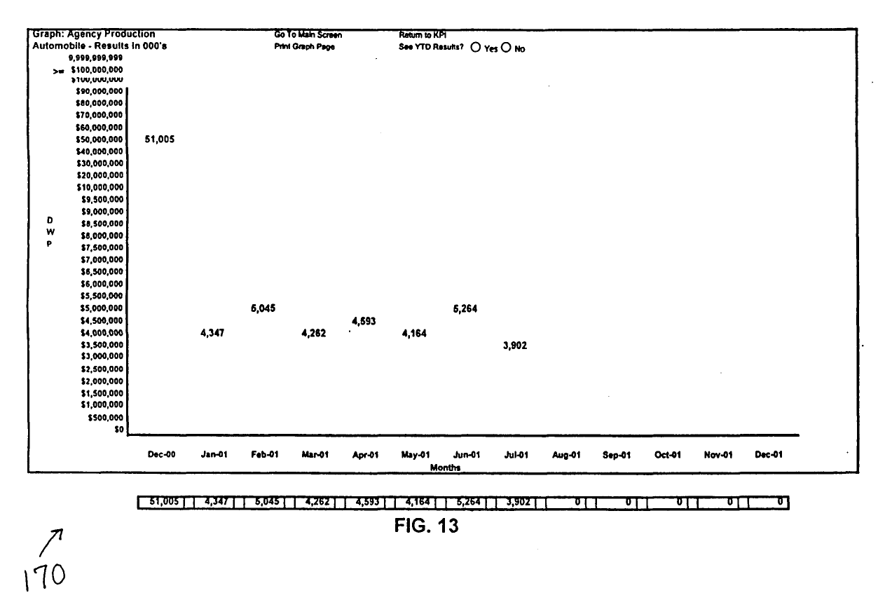

FIG. 13 shows an example of the graphing flexibility available to the Information Presentation System 1 user. Preferably, the Graph Screen 170 will be color-coded in accordance with the Information Presentation System's 1 color-coding convention being used.

Well-known drawing tools are available within the Excel application, which could allow for rapid, customized screen development Since the Information Presentation System 1 is or can be associated with the user's own spreadsheet application, the user's familiarity with the spreadsheet technology will allow the user to easily maintain, and to modify or customize, the Information Presentation System 1. Therefore, the Information Presentation System 1 should be used with an application that the user is comfortable with for example, other spreadsheet applications that can be used include, but are not limited to, Lotus 1-2-3 from the Lotus Development Corporation of Cambridge, Mass., and Quattro Pro from Corel Corporation Limited.

What is claimed is:

1. A method of presenting business analysis information, said method comprising the steps of:
(a) providing a computer system;
(b) installing a computer enabled spreadsheet application onto said computer system, said spreadsheet application comprised of at least one worksheet screen, said at least one worksheet screen comprised of data cells;
(c) developing and installing macros into said spreadsheet application for operating said spreadsheet application;
(d) identifying performance indicators for a business;
(e) assigning each of said performance indicators to at least one of said data cells;
(f) quantifying a performance expectation for each of said performance indicators;
(g) modifying at least one of said spreadsheet application macros with each of said performance expectations;
(h) inputting performance indicator data corresponding to each of said performance indicators into said spreadsheet application;
(i) comparing each said performance indicator with each said performance expectation associated with said performance indicator by using at least one of said spreadsheet application macros; and
(j) displaying said performance indicators data on said computer system.

2. The method of claim 1, wherein said displaying step further comprises the step of: classifying said performance indicators data according to whether said performance indicators data meet plan expectations, do not meet plan expectations but are within an approved variance away from said plan expectations, or differ from said plan expectations by more than said approved variance.

3. The method of claim 2, wherein said displaying step further comprises the step of: displaying said classified performance indicators data by using different colors to indicate whether said performance indicators data meet said plan expectations, do not meet said plan expectations but are within said approved variance away from said plan expectations, or differ from said plan expectations by more than said approved variance.

4. The method of claim 1, wherein said identifying step further comprises the step of identifying leading and lagging performance indicators for a business.

5. A method of implementing a strategic business plan for an organization, said method comprising the steps of:
(a) developing a business performance model for an organization from a financial perspective, a customer perspective, an internal business process perspective, and an organizational learning perspective, said business model yielding results that include the identification of performance indicators for said organization;
(b) developing a computer enabled spreadsheet-based information presentation system using the results of said business model; and
(c) entering an organization's financial and non-financial data corresponding to said performance indicators into said spreadsheet-based information presentation system, said spreadsheet-based information presentation system being adapted to automatically analyze and display said financial and non-financial data.

6. The method of claim 5, wherein said business model developing step includes the steps of:
(a) developing a vision statement for an organization;
(b) developing a strategy statement for an organization;
(c) developing strategic thrusts for an organization; and
(d) developing success factors for said financial perspective, said customer perspective, said internal business process perspective, and said organizational learning perspective, said success factors used for developing said performance indicators.

7. The method of claim 5, further comprising the steps of:
(a) assigning a target value to each of said performance indicators, said ,target value indicating that said performance indicator has at least met organization expectations;
(b) assigning at least one variance to each of said target values, each of said variances either indicating that said performance indicator data was within an acceptable tolerance or outside an acceptable tolerance; and
(c) assigning color-coding to each said target value and each said variance.

8. The method of claim 7, further comprising the steps of:
(a) identifying major cause and effect relationships;
(b) identifying leading measures of actions; and
(c) identifying lagging measures of desired outcomes.

9. The method of claim 8, further comprising the step of: developing at least one spreadsheet screen for said spreadsheet-based information presentation system.

10. The method of claim 9, wherein said spreadsheet screen developing step includes:
(a) developing a main spreadsheet screen for said spreadsheet-based information presentation system;
(b) developing a cause and effect spreadsheet screen for said spreadsheet-based information presentation system;
(c) developing at least one performance indicator results spreadsheet screen for said spreadsheet-based information presentation system;
(d) developing at least one performance indicator description spreadsheet screen for said spreadsheet-based information presentation system;
(e) developing at least one performance indicator help spreadsheet screen for said spreadsheet-based information presentation system;
(f) developing at least one performance indicator targets spreadsheet screen for said spreadsheet-based information presentation system;
(g) developing at least one performance indicator action item spreadsheet screen for said spreadsheet-based information presentation system;
(h) developing a performance indicator action item status spreadsheet screen for said spreadsheet-based information presentation system;
(i) developing at least one performance indicator worksheet spreadsheet screen for said spreadsheet-based information presentation system;
(j) developing at least one data menu spreadsheet screen for said spreadsheet-based information presentation system; and
(k) developing at least one graphical presentation of data spreadsheet screen for said spreadsheet-based information presentation system.

11. The method of claim 10, further comprising the steps of:
(a) developing at least one macro in said spreadsheet-based information presentation system for analyzing and organizing said actual data;
(b) developing links in said spreadsheet-based information presentation system to assist in distributing said actual performance indicator data throughout said spreadsheet-based information presentation system;
(c) developing organization means in said spreadsheet-based information presentation system for organizing said spreadsheet-based information presentation system;
(d) developing a color-coding scheme for visually organizing said actual data of said performance indicators;
(e) inputting and importing said actual data of said performance indicators into said spreadsheet-based information presentation system;
(f) using said at least one macro for comparing said actual data of said performance indicators with said performance indicator target values and variances, and inserting said actual data into a user specified data cell based on said comparison and on said color-coding scheme; and
(g) presenting all information stored within the spreadsheet-based information presentation system on said spreadsheet screens.

12. The method of claim 11, wherein said information presenting step includes:
(a) displaying the relationships between said performance indicators on said cause and effect spreadsheet screen;
(b) displaying detailed information regarding said performance indicators on each of said results spreadsheet screen;
(c) communicating to a user why a user selected performance indicator is important to said user through said user's selection of said description spreadsheet screen associated with said user selected performance indicator;
(d) displaying information to said user regarding means for acquiring further assistance with said spreadsheet-based information presentation system through said user's selection of any of said help spreadsheet screens;
(e) displaying threshold values for a user selected performance indicator through said user's selection of said targets spreadsheet screen associated with said user selected performance indicator;
(f) displaying the status of all strategic action items associated with a user selected performance indicator through said user's selection of said action item spreadsheet screen associated with said user selected performance indicator;
(g) displaying the status of all strategic action items associated with all of said performance indicators to a user through said user's selection of said action item status spreadsheet screen;
(h) displaying actual performance indicator data and said performance indicator target values for a user selected performance indicator through said user's selection of said worksheet spreadsheet screen associated with said user selected performance indicator; and
(i) providing a convenient link to access and display said actual performance indicator data for each of said performance indicators having data stored in said spreadsheet-based information presentation system through a user's selection of said data menu spreadsheet screen.

13. An information presentation system for displaying performance indicators, comprising:
(a) a computer system having computer memory mean for storing data and instructions, and a display system for displaying said information presentation system to a user; and
(b) computer software applications having a computer operating system, and an electronic spreadsheet application, said electronic spreadsheet application having a graphical user interface means for accessing and navigating said information presentation system.

14. The information presentation system of claim 13, further comprising: user controlled means for inserting, modifying, and displaying the information presentation system data contained within the electronic spreadsheet application.

15. The information presentation system of claim 13, further comprising:
electronic spreadsheets, said electronic spreadsheets being customized to contain user-specific information and data, said electronic spreadsheets having user-customized electronic features installed, said electronic spreadsheets capable of being displayed on said display system.

16. The information presentation system of claim 15, wherein said user-specific information and data includes: organization performance indicators.

17. The information presentation system of claim 16, wherein said electronic spreadsheets include:
(a) at least one cause and effect relationship electronic spreadsheet, said cause and effect relationship electronic spreadsheet organizing the cause and effect relationships between said organization performance indicators;
(b) at least one general electronic spreadsheet associated with at least one of said organization performance indicators;
(c) at least one specific electronic spreadsheet associated with at least one of said organization performance indicators;
(d) at least one assistance information electronic spreadsheet; and
(e) at least one worksheet, with each of said at least one worksheets being a centralized data location for at least one of said performance indicators.

18. The information presentation system of claim 17, wherein said electronic features of said electronic spreadsheets include: user specific electronic spreadsheet macros.

19. The information presentation system of claim 13, further comprising electronic spreadsheet macros, said macros organize the access to and the display of said information presentation system data by linking said electronic spreadsheets.

20. A system, said system comprising:
(a) a computer-enabled spreadsheet application;
(b) means for importing business data into said spreadsheet application;
(c) a spreadsheet architecture including a presentation sheet and at least one worksheet, said presentation sheet and said at least one worksheet having at least one data cell, said presentation sheet and said at least one worksheet being in linked relationship; and
(d) macro means programmed into said spreadsheet application for analyzing said business data by comparing said business data to at least one preselected business goal to produce comparison results, for distributing said business data and said comparison results to said data cells, and for highlighting said comparison results.

21. The system as recited in claim 20, wherein said business data is classifiable by a relationship to at least one performance indicator of plural performance indicators, and wherein said at least one worksheet is plural worksheets, each worksheet of said plural worksheets being associated with a performance indicator of said plural performance indicators, and wherein said spreadsheet architecture further comprises a cause and effect sheet in linked relationship to said plural worksheets and to said presentation sheet having a plurality of data cells, said cause and effect sheet presenting relationships among said plural performance indicators.

22. The system as recited in claim 20, wherein said macro means has means for color- coding to highlight said results so that, when said business data is imported by said importing means into said spreadsheet application and said macro means produces said comparison results from said business data, said results are highlighted by color-coding.

23. The system as recited in claim 20, wherein said spreadsheet architecture further includes a plurality of drill down sheets associated with at least one of said performance indicators for presenting more specific information associated with said at least one of said performance indicators, each of said drill down sheets in linked relationship to at least one other of said drill down sheets of said plurality of drill down sheets and in linked relationship to the cause and effect sheet, the presentation sheet, and the worksheets, each of said drill down sheets having a plurality of data cells.

24. The system as recited in claim 20, wherein said spreadsheet architecture further includes at least one goal sheet associated with at least one of said performance indicators for presenting user assigned goals for each of said at least one of said performance indicators, each of said at least one goal sheet in linked relationship to at least one of said plural worksheets and to said presentation sheet, each of said at least one goal sheet having a plurality of data cells.

25. A method of implementing a strategic business plan for an organization, said method comprising the steps of:
(a) developing a balanced business scorecard for an organization from a financial perspective, a customer perspective an organizational learning perspective, and an internal organization process perspective, said organization having a plurality of users;
(b) developing a computer enabled spreadsheet-based information presentation system using the results of said business scorecard, said computer enabled spreadsheet-based information presentation system having a plurality of spreadsheet screens, said business scorecard results include the identification of leading and lagging key performance indicators and key strategic action items for said organization, wherein said computer enabled spreadsheet-based information presentation system is developed by utilizing a systematic computer code building method whereby many iterations of the computer code are build quickly and accurately; and
(c) entering organization financial and non-financial data corresponding to said key performance indicators into said spreadsheet-based information presentation system, said data being actual results associated with said key performance indicators, said spreadsheet-based information presentation system automatically analyzing said financial and non-financial data and displaying said data, wherein the displaying of said data includes the ability of said plurality of users to observe trends in said actual results of said key performance indicators, to compare said actual results of said key performance indicators against performance expectations previously assigned to said key performance indicators by said organization, and to prepare forecasts of future actual results of said key performance indicators against future performance expectations assigned to said key performance indicators.

26. The method as recited in claim 25, wherein said balanced business scorecard developing step includes the steps of:
(a) developing a vision statement for an organization;
(b) developing a strategy statement for an organization;
(c) developing strategic goals for an organization; and
(d) developing critical success factors for said financial perspective, said customer perspective, said organizational perspective, and said internal organization process perspective, said critical success factors being used for developing said key performance indicators within the four perspectives of the Balanced Business Scorecard.

27. The method as recited in claim 26, further comprising the steps of:
(a) assigning a goal value to each of said key performance indicators, each of said goal values indicating current organization expectations for each of said key performance indicators;
(b) assigning at least one variance to said each of said goal values, each of said at least one variance indicating an organization acceptable tolerance away from each of said goal values; and
(c) assigning color coding to each said goal value and each said variance.

28. The method as recited in claim 27, further comprising the steps of:
(a) identifying major cause and effect relationships,
(b) identifying leading measures of actions;
(c) identifying strategic action items; and
(d) identifying lagging measures of desired outcomes.

29. The method as recited in claim 25, said a computer enabled spreadsheet-based information presentation system developing step further comprises the steps of:
(a) developing a main spreadsheet screen for said spreadsheet-based information presentation system, said main spreadsheet screen having a plurality of business strategy variables selected from a group consisting of strategic thrusts, critical success factors, financial perspectives, customer perspectives, organizational learning perspectives, and internal organization process perspectives, wherein each of said leading and said lagging key performance indicators are associated with at least one of said plurality of business strategy variables;
(b) developing a cause and effect spreadsheet screen for said spreadsheet-based information presentation system, said cause and effect spreadsheet screen providing said user with information regarding the cause and effect relationships between said key performance indicators, wherein said leading key performance indicators are displayed in a highlighted fashion to distinguish said leading key performance indicators from said lagging key performance indicators;
(c) developing a user selected key performance indicator results spreadsheet screen for said spreadsheet-based information presentation system, said user selected results spreadsheet screen providing said user with a first level drill-down of information related to said actual results obtained for, and said goal value
(d) developing a user selected key performance indicator description spreadsheet screen for said spreadsheet-based information presentation system, said user selected key performance indicator description spreadsheet screen providing information to said user explaining the importance of said selected key performance indicator;
(e) developing a user selected key performance indicator help spreadsheet screen for said spreadsheet-based information presentation system, said user selected key performance indicator help spreadsheet screen providing said user with information regarding usage of said spreadsheet-based information presentation
(f) developing a user selected key performance indicator targets spreadsheet for said spreadsheet-based information presentation system, said user selected key performance indicator targets spreadsheet screen providing the user with information concerning said at least one variance and said color coding assigned to said selected key performance indicator;
(g) developing a user selected key performance indicator action item spreadsheet screen for said spreadsheet-based information presentation system, said user selected key performance indicator action item spreadsheet screen providing the user with the ability to assign said identified strategic action items to said user selected key performance indicator action item spreadsheet screen and for providing said user with the ability to monitor said identified strategic action items so assigned;
(h) developing a key performance indicator action item status spreadsheet screen for said spreadsheet-based information presentation system;
(i) developing at least one user selected key performance indicator worksheet spreadsheet screen for said spreadsheet-based information presentation system, each of said user selected key performance indicator worksheet spreadsheet screens being used to provide the level of information requested by said user of said spreadsheet-based information presentation system; and
(j) developing a data menu spreadsheet screen of said spreadsheet-based information presentation system, wherein each of said plurality of spreadsheet screens is customizable to meet said user's information needs.

30. The method as recited in claim 29, further comprising the steps of:
(a) developing at least one macro in said spreadsheet-based information presentation system for analyzing and organizing said actual data;
(b) developing links in said spreadsheet-based information presentation system to assist in distributing said actual results of said key performance indicators data throughout said spreadsheet-based information presentation system;
(c) developing organization means in said spreadsheet-based information presentation system for organizing said spreadsheet-based information presentation system;
(d) inputting said actual results of said key performance indicators data into said spreadsheet-based information presentation system, said inputting includes the importation of said actual data;
(e) using said least one micro for comparing said actual result of each of said key performance indicators with the appropriate said assigned goal value for said key performance indicator and also with said at least one variance, and inserting said actual result into a user specified data cell based on said comparison; and
(f) presenting all information stored within the spreadsheet-based information presentation system on said plurality of spreadsheet screens.

31. The method as recited in claim 30, wherein said information presenting step includes:
(a) displaying the relationships between said key performance indicators on each of said cause and effect spreadsheet screens;
(b) displaying detailed information regarding said key performance indicators on each of said results spreadsheet screens;
(c) communicating to a user why a user selected key performance indicator is important to said user through said user's selection of said description spreadsheet screen associated with said user selected key performance indicator;
(d) displaying information to said user regarding means for acquiring further assistance with said spreadsheet-based information presentation through said user's selection of said help spreadsheet screen;
(e) displaying threshold values for a user selected key performance indicator through said user's selection of said targets spreadsheet screen associated with said user selected key performance indicator;
(f) displaying the status of all strategic action items associated with all user selected key performance indicator through said user's selection of said action item spreadsheet screen associated with said user selected key performance indicator;
(g) displaying the status of all strategic action items associated with all of said key performance indicators to a user through said user's selection of said action item status spreadsheet screen;
(h) displaying actual key performance indicator data and said performance indicator goal values for a user selected performance indicator through said user's selection of said worksheet spreadsheet screen associated with said user selected key performance indicator; and
(i) providing a convenient link to access and display said actual key performance indicator data for each of said key performance indicators having data stored in said spreadsheet-based information presentation system through a user's selection of said data menu spreadsheet screen.

32. An information presentation system for displaying key performance indicators, comprising:
(a) a computer system, said computer system having a computer memory means for storing data and instructions and a display system for displaying information for said information presentation system to a user, said display system having a graphical user interface mean for accessing and navigating said information presentation system;
(b) computer software applications carried by said computer system said computer software including a computer operating system, and an electronic spreadsheet application having a plurality of spreadsheet screens; and
(c) user controlled means for inserting, modifying, and displaying the information presentation system data contained within said information presentation system on said plurality of spreadsheet screens, said information presentation system data being associated with leading and lagging strategic performance indicators, wherein said user controlled means utilizes a systematic computer code building method whereby many iterations of the computer code are built quickly and accurately, wherein said user controlled means allows said displaying of said data to provide said user the ability to observe trends in the actual result of each of said leading and lagging strategic performance indicators, compare said actual result of each of said leading and lagging strategic performance indicators against an expected result previously assigned to said each of said leading and lagging strategic performance indicators by said user, and prepare forecasts of a future actual result of said each of said leading and lagging strategic performance indicators against a future expected result assigned to said each of said leading and lagging strategic performance indicators by said user, wherein said user controlled means associated a color coding scheme with each expected result for said each of said leading and lagging strategic performance indicators whereby each cell in which said actual result of said each of said leading and lagging strategic performance indicators is displayed on said plurality of spreadsheet screens is either green if said actual result of said each of said leading and lagging strategic performance indicators is not below said expected result, yellow if said actual result is below said expected result but said actual result is within a variance assigned by said user to said expected result, or red if said actual result is below said expected result and is outside said variance, wherein, if said expected result is changed by said user, said user controlled means will automatically change the color coding of each of said cells which contain an actual result that falls within a different portion of the color coding scheme, wherein if said variance is changed by said user, said user controlled means will automatically change the color coding of each of said cells which contain an actual result that falls within a different portion of the color coding scheme, wherein said user controlled means allows for the tracking of either a positive or a negative actual result of said each of said leading and lagging strategic performance indicators and compares said positive or said negative actual result against said expected result previously assigned to said each of said leading and lagging strategic performance indicators by said user regardless of whether an above said expected result or below said expected result is a positive outcome for said user, wherein said user controlled means allows for the inserting, modifying, and displaying of said information presentation system data through web based means, wherein said user controlled means provides navigational buttons which allow said user to easily navigate between said plurality of spreadsheets and which allow for the maximization of the capacity of each of said plurality of spreadsheets, wherein said user controlled means provides print buttons which allow said user to easily print any of said plurality of spreadsheet screens, wherein said user controlled mean provides freeze and unfreeze buttons which allow said user to easily view and scroll said information presentation system data displayed on said any of said plurality of spreadsheets screens, wherein said user controlled means provides an interface between said information presentation system and said user's e-mail system so that said user can electronically transmit said any of said plurality of spreadsheet screens as an e-mail attachment, wherein said user controlled means uses the graphing capabilities of said electronic spreadsheet application so that custom built graphs can be created showing said information presentation system data, including said actual results, said expected results, said variances, and said color scheme.

33. The information presentation system as recited in claim 32, further comprising:
(a) at lest one link said user's organization's planning and budgeting functions and said strategic performance indicators; and
(b) at least one link between said user's organization's human resources functions and said strategic performance indicators.

34. The information presentation of claim 32, wherein said information presentation system further comprises an electronic database having graphing features, said graphing features being accessible to and used by said user controlled means, said electronic database being easily used and navigated through the use of said navigational buttons.

35. The information presentation system as recited in claim 32, wherein said information presentation system further comprises a means for developing a business strategy.

36. The information presentation system as recited in claim 35, wherein said business strategy means uses a business strategy scorecard system as a tool for facilitating communications during a business strategy consultation phase prior to the implementation of said information presentation system is the organization of said user so that the parameters needed by said information presentation system can be developed and the needs of said information presentation system data can be determined early in said business strategy consultation phase, thereby allowing for quicker extraction of the data needed by said information presentation system from said user's organization.

37. The information presentation system as recited in claim 36, wherein said business strategy scorecard system assists in developing said leading and lagging strategic performance indicators, each said expected result for each of said leading and lagging strategic performance indicators, each said variance associated with each of said leading and lagging strategic performance indicators and key strategic action items, said key strategic action items being key strategic initiatives undertaken by said user's organization.

38. The information presentation system as recited in claim 36, wherein said information presentation system displays said information presentation system data in an executive display format, wherein said executive diary format allows said user to view said data that is associated with said leading and lagging strategic performance indicators and key strategic action items.

39. The information presentation system as recited in claim 37, wherein the channels of communication concerning said business strategy as developed by said business strategy means and as presented by said information prevention system is enhanced by the organization-wide computer access to said data and information presented by said information presentation system and by focusing the business strategy meetings held by said user's organization to said data associated with said strategic performance indicators and said key strategic action items.

40. The information presentation system as recited in claim 37, wherein said plurality of spreadsheet screens further comprise:
(a) a main spreadsheet screen for said information presentation system, said main spreadsheet screen having a plurality of business strategy variables selected from a group consisting of strategic thrusts, critical success factors, financial perspectives, customer perspectives, organizational learning perspectives, and internal organization process perspectives, wherein of said leading and lagging key performance indicators are associated with at least one of said plurality of business strategy variables;
(b) a cause and effect spreadsheet screen for said information presentation system, said cause and effect spreadsheet screen providing said user with information regarding the cause and effect relationships between said key performance indicators, wherein said leading key performance indicators are displayed in a highlighted fashion to distinguish said leading key performance indicators from said lagging key performance indicators;
(c) at least one user selectable key performance indicator results spreadsheet screen for said information presentation system, said user selectable results spreadsheet screen providing said user with a first level drill-down of information related to said actual results obtained for, and said goal value assigned to, said selectable key perforce indicator;
(d) at least one user selectable key performance indicator description spreadsheet screen for said information presentation system, said user selectable key performance indicator description spreadsheet screen providing information to said user explaining the importance of said selectable key performance indicator;
(e) at least one user selectable key performance indicator help spreadsheet screen for said information presentation system, said user selectable key performance indicator help spreadsheet screen providing said user with information regarding usage of said information presentation system;
(f) at least one user selectable key performance indicator targets spreadsheet screen for said information presentation system, said user selectable key performance indicator targets spreadsheet screen providing the user with information concerning said at least one variance and said color coding assigned to said selectable key performance indicator.
(g) at least one user selectable key performance indicator action item spreadsheet screen for said information presentation system, said user selectable key performance indicator action item spreadsheet screen providing the user with the ability to assign said strategic action items to said user selectable key performance indicator action item spreadsheet screen and for providing said user with the ability to monitor said strategic action items so assigned;
(h) at least one user selectable key performance indicator action item status spreadsheet screen for said information presentation system;
(i) at least one user selectable key performance indicator worksheet spreadsheet screen for said information presentation system, each of said user selectable key performance indicator worksheet spreadsheet screens being used to provide the level of information requested by said user of said information presentation system;
(j) at least one user selectable data menu spreadsheet screen for said information presentation system; and
(k) means for inserting, modifying and displaying the information presentation system data contained within said information presentation system on said plurality of spreadsheet screen, said information presentation system data being associated with leading and lagging strategic performance indicators, wherein said user controlled means utilizes a systematic computer code building method whereby many iterations of the computer code are built quickly and accurately, wherein said user controlled means allows said displaying of said data to provide said user the ability to observe trends in the actual result of each of said leading and lagging strategic performance indicators, compare said actual result of each of said leading and lagging strategic performance indicators against an expected result previously assigned to said each of said leading and lagging strategic performance indicators by said user, and prepare forecasts of a future actual result of said each of said leading and lagging strategic performance indicators against a future expected result assigned to said each of said leading and lagging strategic performance indicators by said user, wherein said user controlled means associated a color coding scheme with each expected result for said each of said leading and lagging strategic performance indicators whereby each cell in which said actual result of said each of said leading and lagging strategic performance indicators is displayed on said plurality of spreadsheet screens is either green if said actual result of said each of said leading and lagging strategic performance indicators is not below said expected result, yellow if said actual result is below said expected result but said actual result is within a variance assigned by said user to said expected result, or red if said actual result is below said expected result and is outside said variance, wherein, if said expected result is changed by said user, said user controlled means will automatically change the color coding of each of said cells which contain an actual result that falls within a different portion of the color coding scheme, wherein if said variance is changed by said user, said user controlled means will automatically change the color coding of each of said cells which contain an actual result that falls within a different portion of the color coding scheme, wherein said user controlled means allows for the tracking of either a positive or a negative actual result of said each of said leading and lagging strategic performance indicators and compare said positive or said negative actual result against said expected result previously assigned to said each of said leading and lagging strategic performance indicators by said user regardless of whether an above said expected result or below said expected result is a positive outcome for said user, wherein said user controlled means allows for the inserting, and displaying of said information presentation system data through web based means, wherein said user controlled means provides navigational buttons which allow said user to easily navigate between said plurality of spreadsheets and which allow for te maximization of the capacity of each of said plurality of spreadsheets, wherein said user controlled means provides print buttons which allow said user to easily print any of said plurality of spreadsheets, wherein said user controlled means provides freeze and unfreeze buttons which allow said user to easily view and scroll said information presentation system data displayed on said any of said plurality of spreadsheet screens, wherein said user controlled means provides an interface between said information presentation system and said user's e-mail system so that said user can electronically transmit said any of said plurality of spreadsheet screens as an e-mail attachment, wherein said user controlled means uses the graphing capabilities of said electronic spreadsheet application so that custom built graphs showing said information presentation system data, including said actual results, said expected result, said variances, and said color coding scheme, and wherein each of said plurality of spreadsheet screens is customizable to meet said user's business and information needs.

41. The information presentation system as recited in claim 38, wherein said executive diary format allows said user to focus on said key strategic action items so that they are not overlooked by said users of said information presentation system can be readily noted for discussion during management meetings at said user's organization.

42. The information presentation system as recited in claim 40, wherein said user controlled means for comprises a plurality of macros written into said information presentation system, said macros being written into said information presentation system by using a rapid replicated code technology, said rapid replicated code technology being a systematic computer code building method whereby many iterations of the computer code are built quickly and accurately.
